(19) United States
(12) Patent Application Publication
(10) Pub. No.: US 2006/0129815 A1
(43) Pub. Date: Jun. 15, 2006

(54) Generation of identities and authentication thereof

(76) Inventor: Adrian Baldwin, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/224,558

(22) Filed: Sep. 12, 2005

(30) Foreign Application Priority Data
Sep. 18, 2004 (GB) 0420789.0

(51) Int. Cl. H04L 9/00

(52) U.S. Cl. 713/168

(57) ABSTRACT

A method of generating an identity for a first party that changes over time and which can at all times be authenticated by second party wherein the method includes the steps of: the first and second parties establishing a secret between them, the secret including an entity the value of which changes over time and first and second cryptographically strong functions used to operate in sequence on the current value of that time dependent entity to generate an identity for the first party; and for predetermined intervals each of the first and second parties generating a fresh identity for the first party.

### FIELD OF THE INVENTION

The invention relates to methods of generating identities for a first party and authentication thereof by a second party.

### BACKGROUND OF THE INVENTION

There are, in the prior art, a number of ways of authenticating the identity of a party when exchanging information by electronic means, such as when a user logs a PC onto a computer network, a user switches on their mobile telephone and enters a mobile telephone network, when parties make purchases over the Internet, or provide documents in electronic form etc. One method is Public Key Infrastructure (PKI) which is system of digital certificates issued by Certificate Authorities (CAs), although there is no standard for implementation of this and therefore it has not yet been widely adopted. In PKI public/private (otherwise known as asymmetric) key pairs are used, where the public key of a pair is used to encrypt data and the private key of the same pair is used to decrypt and thus recover the data. A first user who wants a digital certificate issued generates a key pair and forwards the public key to their chosen CA. The chosen CA issues a certificate including the first user's name and public key, and any other appropriate information, and the CA's digital signature. If the first user is doing business with a second user who wants their identity verified then they can obtain the first user's certificate either from the first user or direct from the CA.

Certificates can be personal to a specified user or can be attribute certificates which, for example, specify the role, rights or attributes of or allocated to the holder.

Such digital certificates include an expiry date, but clearly there can be a problem when the certificate in fact becomes invalid for one reason or another, such as loss of the first user's private key, before the expiry date. The second user thus also needs to check that the first user's certificate has not been revoked if they wish to be absolutely sure that the first user is who they claim to be and/or currently has the relevant role, rights or attributes they claim to have. This can most readily be undertaken by asking the CA to provide a list of revoked certificates and then checking that the first user's certificate is not amongst them. This all makes the process less simple to use than would otherwise be the case and is one reason why it is not yet widely adopted.

One solution to this which has been proposed is that the CA should issue short term certificates and re-issue them using the same key pair automatically as they expire unless informed that they should not be reissued. It is not known whether this suggestion has been implemented.

Another prior art solution, suitable for some situations only, such as for authenticating the identity of a user logging a PC into a computer network, uses a physical authentication token which is allocated to a particular user. This is a small device which has a screen on which is displayed a number which changes over time. Somewhere in the computer network is a unit which is running the same number generation process and thus knows the correct authentication number for each user at any given time. To log a PC onto the network the user needs their name (or other identity information personal to them), their password and the current value from their allocated authentication token. This is more secure that the more normal level of access information which simply includes the user's name and password, particularly as most users select passwords which relate to something in their every day life, to assist them in remembering the password, and thus the passwords can be guessed quite readily if enough is known about the user.

For additional security the authentication token may require a PIN number to be entered before displaying the current number.

Another issue with the prior art is that a user maintains the same identity all the time, or for very long periods of time. This means that the user's activities can be traced over long periods of time. In some circumstances this may not be an issue but in, for example, mobile phone use or Internet transactions this may be considered undesirable.

It is desirable to provide an alternative way of generating a first party's identity which can be authenticated by a second party.

### SUMMARY OF THE INVENTION

According to first aspect of the present invention there is provided a method of generating an identity for a first party that changes over time and which can at all times be authenticated by second party wherein the method includes the steps of:

the first and second parties establishing a secret between them, the secret including an entity the value of which changes over time and first and second cryptographically strong functions used to operate in sequence on the current value of that time dependent entity to generate an identity for the first party; and

for predetermined intervals each of the first and second parties generating a fresh identity for the first party.

### BRIEF DESCRIPTION OF THE DRAWINGS

Embodiments of the invention will now be described, by way of example only, with reference to the accompanying drawings in which:

FIG. 1 schematically illustrates a computer network, or the like, to which a user wishes to log on;

FIG. 2 is a flow chart of the method as applied to the logging on the user to the network of FIG. 1;

FIG. 3 schematically illustrates a mobile communications network to which a user wishes to connect their mobile phone;

FIG. 4 is a flow chart of the method as applied to the connection of a mobile phone to the communications network of FIG. 3.

### DETAILED DESCRIPTION OF THE PREFERRED EMBODIMENTS

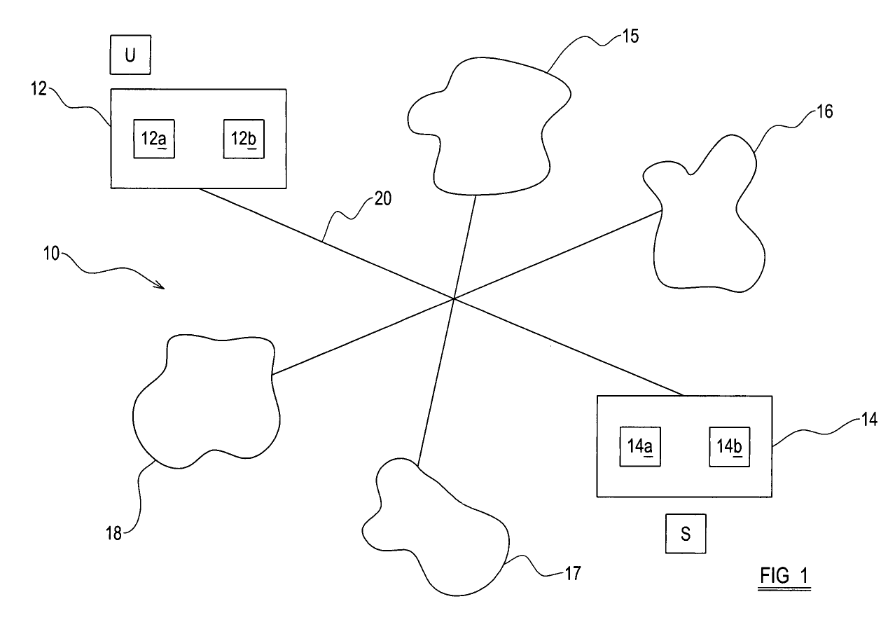

Referring to FIG. 1 a network 10 to which a first party, in this case a user U, is connected is schematically illustrated. The user U has a PC 12, and the network 10 further includes a second party, in the form of a user management unit 14, and various IT systems 15, 16, 17 and 18 to which individual users may or may not be given access depending on their access rights within the network 10. The connections 20 of the network 10 may be hardwired or wireless.

Access to the network 10 is controlled by a network supervisor S. For the user U to log onto their PC 12 they need a name N, which in this case this varies with time, so that at any particular time i it has a value Nᵢ. However both the user U and network supervisor S must be able to calculate the current value Nᵢ in order for the use to be able to log in. Thus, when the user U wishes to log their PC 12 into the network 10 the method according to the invention is as follows.

Before the first time the user U logs onto the network the user U contacts the network supervisor S, who has access to the user management unit 14, and arranges for a secret relating to the user's log-in procedure shared between them. This secret comprises a sequence value vᵢ, two functions ƒ and s, and one or more additional items to be used as input to the function, such as a password and temporal data. This additional information has a value at a time i of aᵢ.

This secret sharing is most likely dealt with off-line, bearing in mind that it is arranging for the user's log-in, but the secret is entered into a memory 14a of the user management unit 14 by the network supervisor S. The functions ƒ and s which comprise part of the secret are stored in a memory 12a of the PC 12 by the user U.

The temporal data must be something for which the current value, in any time period i, cannot be determined from knowledge of previous values by anyone other than the first and second parties, and preferably not even by them. The temporal data may for examples be some contemporary event the current value of which is unpredictable and can readily be obtained, such as the closing level of the FTSE 100 index at the end of a trading day, or an authentication token (as described in the introductory portion of this specification) and a mirror unit within the user management unit 14, which generate changing numbers over time. The functions ƒ and s must be a cryptographically strong functions, for example hash functions such as SHA1. They may be the same function or different functions, with the latter option providing slightly greater security.

The user U and the user management unit 14 thus share a secret comprising at least three things; these being knowledge of an initial value V of a sequence which varies with time, the functions ƒ and s, and the chosen temporal data. When the user U starts to log their PC 12 into the network 10 they enter their password in the normal way. However, instead of their normal name they have to generate their identity by calculation using the shared secret. Thus the PC is used to calculate the current value vᵢ of the sequence, this being the result of the calculation:
vᵢ=s(vᵢ₋₁)

and the user enters the current value aᵢ of the temporal data, and then the new identity Nᵢ, for the relevant time period i, is calculated by the PC 12 using the following:
Nᵢ=ƒ(vᵢ,aᵢ)
which is used as the user's identity for logging the PC 12 into the network 10. This identity is sent to the user management unit 14 via the network connections 20.

The user management unit 14 can authenticate the identity Nᵢ, because it can also generate the same identity Nᵢ for the same time period i, in it's processor 14b, using the shared secret, and compare them. The user management unit 14 can therefore approve the logging on of the PC 12 under the identity Nᵢ, for that time period i, and can also indicate the appropriate access rights for that identity to the various IT systems 15, 16, 17 and 18 on the network 10.

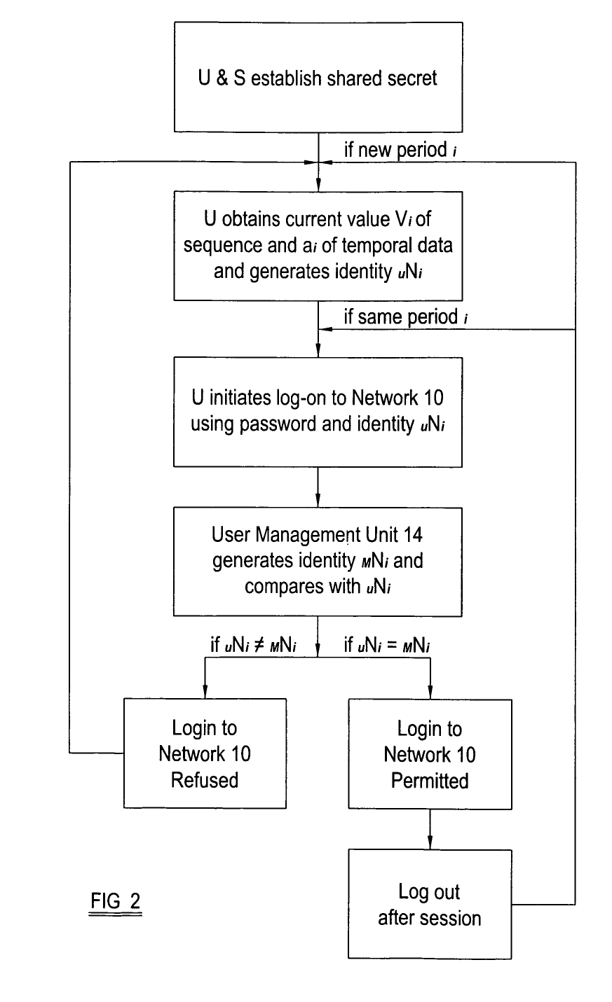

The flow of this embodiment is set out in FIG. 2.

The value v of the sequence changes at predetermined intervals, which may be regular, such as once a day or once a week, or irregular, depending on the type of entity chosen and the frequency required. Thus the user U might have a new identity on the network 10 each day, or each time they log in. The user management unit 14 will have a record of a user's activities on the network 10, because it will be able to relate the sequence of identities to the user U, but the other IT systems on the network 10 will not have that overview as they will simply see different identities.

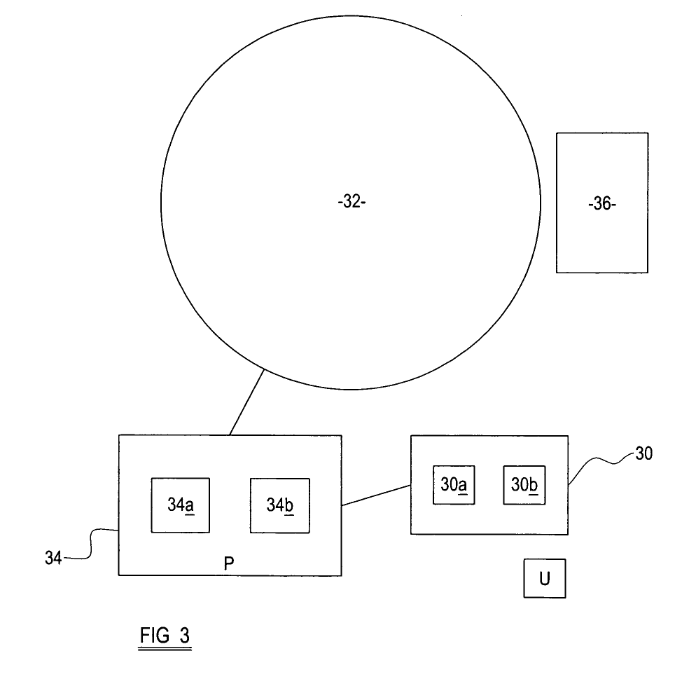

With reference to FIG. 3, the invention works substantially identically for a user U having a mobile phone 30 wishing to connect to a mobile telephone network 32 via their service provider 34 (which is often not the network provider). Conventionally each mobile phone, or other device which can connect to such communications networks, has a SIM card 38 which has a unique number (SIM value) attributed to it and which is used as the identity when the phone 30 is connected to the network 32. Thus each phone has a consistent identity and it's use can be tracked readily by observers of the network 32. This includes being able to track the geographical use of the phone 30 over time which many users might consider undesirable. The invention limits the number of parties who can do this.

In the invention, rather than always using the SIM value as the identity for the phone 30 it is used as the initial identity and then as a seed into the generation of a sequence of identities for a succession of time periods. For the first time period 1 the identity N₁, is calculated from the SIM value X₁:
N₁=ƒ(X₁)
and the second time period, 2 the identity N₂ is calculated using a double function, thus:
X₂=s(X₁)
and
N₂=ƒ(X₂).

Thus for later time periods i the pattern is Xᵢ₊₁=s(Xᵢ), and Nᵢ₊₁=ƒ(Xᵢ₊₁). The generation of the sequence of identities for the mobile phone 30 is clearly undertaken in a processor 30a within the phone 30 and within a processor 34a at the service provider 34, each also having sufficient memory 30b and 34b to retain the current value Xᵢ of the sequence ready for generation of the next identity Nᵢ₊₁. There is no requirement for the mobile phone 30 to retain a record of the identities used, but clearly there is for the service provider 34 to do so in order that they can collate the use of the network 32 by the phone 30 and bill the user U accordingly.

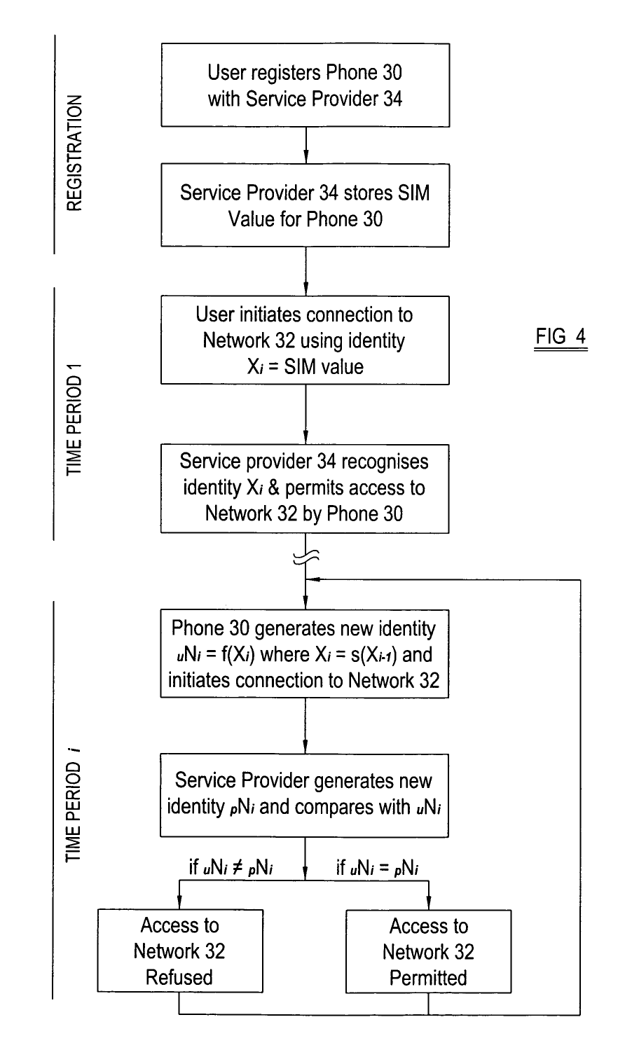

The flow of this embodiment is set out in FIG. 4.

In this case the entity with the changing value is in fact the series of identity precursors Xᵢ, and this is the simplest embodiment of the invention, and the “secret” is readily established between the mobile phone M and the network provider P when the mobile phone M is first registered with the network provider P.

As for the first embodiment described the functions ƒ and s used to generate the sequence of identities must be cryptographically strong functions, such as hash function SHA1, so that an observer of the identity cannot predict the sequence. Again they may be the same function used twice in series or different functions.

Thus this method has the benefit that the service provider 34 can keep a record of a particular user's use of the network 32, and bill them for it, but the network provider 36 cannot as they cannot identify which identities used over a period of time are being used by the particular user U. This has implications for personal privacy as it reduces the number of parties who can track, in this case, the user's mobile phone 30 and therefore their physical movements around the geographical area covered by the network 32.

A development of the method described above is applicable in situations where an encryption key is required to address the problem of revocation of digital certificates.

Encryption keys may be symmetric, i.e. where the same key is used to encrypt and decrypt data (e.g. Data Encryption Standard known as DES), or asymmetric comprising a key pair i.e. where one part of the pair is used to encrypt data and the other part of the pair is used to decrypt the data (e.g. Public Key Infrastructure known as PKI). In the latter case data is encrypted using a public key, i.e. one which the holder of the key pair makes freely available, and decrypted using a private key, i.e. one which the holder of the key pair keeps secret, and therefore the key pair is often called a public/private key pair.

The most widely used encryption system based on the use of asymmetric key pairs is known as the RSA Cryptosystem, which has essentially become the industry standard and is embedded in many widely used software packages for Internet access etc. For more information see “Frequently Asked Questions about Today's Cryptography” issued by RSA Laboratories and downloadable from their website (www.rsasecurity.com/rsalabs).

The user U and its chosen certificate authority CA must first establish a secret between themselves for use in the method according to the invention. This may be undertaken off-line or by using a non-anonymous PKI identity and using the digital certificate from that identity to exchange the secret. Once this has been done then, for each time period, the user U and certificate authority CA can generate matching identities for the user U exactly as previously described for the other embodiments. The identities are however not used by the user U to log onto a network but rather as input into the generation of public/private key pairs. That is each identity is used as the seed (or entropy) for a pseudo random number generator in order to generate two large prime numbers which are then used to generate a public/private key pair (as described in “Frequently Asked Questions about Today's Cryptography” referred to above) for the user U for relevant time period.

As the user U and certificate authority CA generate identical keys for each time period, at the predetermined intervals, the CA can always issue a current digital certificate to authenticate the user's current identity number and key at the start of the relevant period. If the time periods are sufficiently short the issue of revoked certificates is no longer of relevance. The user U could obtain the certificate from the CA at the start of each period or refer any third party that wanted a certificate to the CA or to a CA url where they can pick the certificate up.

Clearly this method would in general be implemented using software, and this would comprise the following functional modules, firstly in respect of the user.

a) An Initialisation Module—Which either generates the secret or has this input into it by the user, and binds this with the user information required by the CA, sends this package to the CA, and receives confirmation from the CA that the users identities will be certified. The module also places the secret into a keysafe (see below).

b) A Keysafe—in which is stored the secret, and which typically requires a password to be unlocked.

c) An Input Module—For each time period, obtains the current value of the temporal data, e.g. by receipt of the users pin, receipt of the current value on the users authentication token, or access to the last closing value of the FTSE 100 Index.

d) Identity Generation Module—Uses the shared secret and input data to create the new identity for each time period, and stores the current value in the key safe.

e) Key Generation Module—Uses appropriate data, Kᵢ, as input to a pseudo random number generator to generate two large primes and thus subsequently a public/private key pair for the time period i. The appropriate data cannot be the current identity Nᵢ as to do so would compromise security. Thus Kᵢ may for examples be calculated either using the same input data as for Nᵢ but with a different function ƒ′, thus Kᵢ=ƒ(vᵢ,aᵢ), or using the same input data and additional data bᵢ and the same function ƒ thus Kᵢ=ƒ(vᵢ,aᵢ,bᵢ).

f) Certificate Fetching Module—Contacts the CA at the start of each time period to obtain the current certificate from the CA.

g) Key Installation Module—Installs the current key into the encryption/decryption software for use during the current time period.

The initialisation module will only be used when the user first registers with the CA, whilst the other modules will be used in each time period.

The software would comprise the following functional modules, now in respect of the CA.

A) Initialisation Module—Sends registration information to users and accepts registration requests from users (see a) above).

B) Registration Module—for checking and processing of registration requests received from users, including for input of any off-line checks undertaken and issuance of acknowledgement to users once process complete.

C) Initiate Certificate Generation Module—Places the shared secret (obtained via a) above) in to a secret store and creates a list of what certificates need to be generated and when, along with necessary information for inclusion in them.

D) Certificate Generation Loop—

i) Input Module—as for c) above, obtains the additional information needed to generate the certificate for the current time period;

ii) Identity Generation Module—as for d) above, generates the identity for the current period, and stores the current value in the secret safe;

iii) Key Generation Module—as for e) above, uses the appropriate data Kᵢ as input to generate a public/private key pair for the time period;

iv) Create & Sign Certificate—using the identity and key for the current time period and place in certificate directory to be accessible for collection by the user.

In this case the first, second and third modules are only used when registering the user at the outset and the Certificate Generation Loop is run every time period to create a new certificate.

Clearly to be able to generate the matching identities, and from them the user's key, the second party which authenticates the user's identity must have access not only to the shared secret but also to the key generator, at least in respect of the public key of a public/private key pair. This gives them more information than would normally be the case, and indeed with all this information to hand they could masquerade as the user. In closed systems, such a closed computer network described above, this may not be an issue but in the case of the relationship between a user and a CA it may be considered to be one. One option is for tamper proof hardware to be built which has embedded within it the shared secret and key generator and is located at or with a third party, then as and when a new identity is created by the user they notify the third party and the relevant information required for generation of the new certificate is forwarded to the CA.

Although the methods described above include a secret comprising just a single temporal data set and two functions ƒ and s, the secret may include one or more additional entities such that the current values of each entity, aᵢ, bᵢ etc., included are operated on by the functions ƒ and s to generate the identity N, i.e. Nᵢ₊₁=ƒ(vᵢ,aᵢ,bᵢ). Thus the secret may for example include a first temporal data set being a current event, with a current value aᵢ, and a second temporal data set being an authentication token, with a current value bᵢ. In addition other elements may be operated on by the functions ƒ and s to generate the identity N, such as the previous value of an time dependent entity as well as the current value of the entity.

1. A method of generating an identity for a first party that changes over time and which can at all times be authenticated by a second party wherein the method includes the steps of:
the first and second parties establishing a secret between them, the secret including an entity the value of which changes over time and first and second cryptographically strong functions used to operate in sequence on the current value of that entity to generate an identity for the first party; and
for predetermined intervals each of the first and second parties generating a fresh identity for the first party.

2. A method according to claim 1 wherein the time dependent entity and the first and second cryptographically strong functions are provided by the first party to the second party.

3. A method according to claim 1 wherein the time dependent entity and the first and second cryptographically strong functions are provided by the second party to the first party.

4. A method according to claim 1 wherein each of the time dependent entity and the first and second cryptographically strong functions is provided by the first party to the second party, or by the second party to the first party.

5. A method according to claim 1 wherein the time dependent entity is or includes a current event the value of which changes in an unpredictable way.

6. A method according to claim 1 wherein the time dependent entity is or includes a time dependent variable.

7. A method according to claim 6 wherein the time dependent variable is a random or quasi-random number generator.

8. A method according to claim 1 wherein the identity is used directly as an identity of the first party.

9. A method according to claim 1 wherein the time dependent entity is used as a seed in a key generator to generate a symmetric key or a public/private key pair for the first party for use with the identity.

10. A method according to claim 9 wherein the second party is a certificate authority and issues a digital certificate based on the first party's identity and public key.

11. A method according to claim 1 wherein the secret includes first and second time dependent entities the value of each which changes over time.

12. A method according to claim 1 wherein the predetermined time intervals are fixed intervals.

13. A method according to claim 1 wherein the predetermined time intervals are variable and dependent upon an event occurring or a value of the time dependent entity changing in a predetermined way.

14. Program product operable by the processor of a first party to generate an identity for the first party that changes over time by:
establishing a secret with a second party, the secret including an entity the value of which changes over time and first and second cryptographically strong functions used to operate in sequence on the current value of that entity to generate an identity for the first party; and
for predetermined intervals generating synchronously with the second party a fresh identity for the first party.

15. Program product operable by the processor of a second party to generate an identity for a first party that changes over time by:
establishing a secret with the first party, the secret including an entity the value of which changes over time and first and second cryptographically strong functions used to operate in sequence on the current value of that entity to generate an identity for the first party; and
for predetermined intervals generating synchronously with the first party a fresh identity for the first party.

16. A management unit of a network operable to generate an identity which changes over the time for a node connected to the network to control access to the network by the node wherein the management unit and node establish a secret between them, the secret including an entity the value of which changes over time and first and second cryptographically strong functions and for predetermined intervals the management unit generates a fresh identity for the node by using the first and second cryptographically strong functions to operate in sequence on the current value of the time dependent entity to generate an identity for the node.

17. A management unit according to claim 16 wherein the network is a computer network and the node is a personal computer.

18. A management unit according to claim 16 wherein the network is a telephone network and the node is a mobile telephone.

19. A node of a network which includes a management unit which controls access to the network by the node, the node being operable to generate an identity for itself which changes over time wherein the management unit and node establish a secret between them, the secret including an entity the value of which changes over time and first and second cryptographically strong functions, and for predetermined intervals the node generates a fresh identity for itself by using the first and second cryptographically strong functions to operate in sequence on the current value of the time dependent entity.

20. A node according to claim 19 wherein the network is a computer network and the node is a personal computer.

21. A node according to claim 19 wherein the network is a telephone network and the node is a mobile telephone.

22. A method of generating an identity for a party that changes over time and which can at all times be authenticated by a further party, the method including the steps of:
establishing a secret for the party which includes: (a) an entity, the value of which changes over time; and (b) first and second cryptographically strong functions used to operate in sequence on the current value of that entity to generate an identity for the party; and
at predetermined intervals, generating a fresh identity for the party.

23. A method according to claim 22 wherein the secret is shared by the party and the further party, and wherein both parties generate the fresh identity at the predetermined intervals of time.
